(19) United States
(12) Patent Application Publication
(10) Pub. No.: US 2025/0375333 A1
(43) Pub. Date: Dec. 11, 2025

(54) PATIENT ISOLATION STRUCTURE

(71) Applicant: B-B-L PROTECT LIMITED, Manchester (GB)

(72) Inventor: Russell CLIFTON, Manchester (GB)

(21) Appl. No.: 18/876,316

(22) PCT Filed: Jun. 21, 2022
(86) PCT No.: PCT/GB2022/051572

§ 371 Date: Dec. 18, 2024

(30) Foreign Application Priority Data
Jun. 21, 2021 (GB) 2108897.6

(51) Int. Cl. A61G 10/00; A61G 1/044

(52) U.S. Cl. CPC A61G 10/005; A61G 1/044

(57) ABSTRACT

A patient isolation structure comprising a base sheet, a plurality of demountable support ribs over the patient passing above the patient support. A patient cover is supported in place by the ribs, with ribs extending downwards, either side of the normal position of a patient on the patient support. The ribs hold the cover away from the position of a patient on the patient support.

### TECHNICAL FIELD

This invention relates to a patient isolation structure for patient transport systems.

### BACKGROUND

Virus or bacterial infected patients can require transport to hospitals to be treated. This poses a risk to various people involved in their transport and contamination of their working environments. For example, transporting ill patients to hospitals requires the use of an aircraft, helicopters and/or and ambulances. Often, currently patients are carried secured to an open stretcher. This firstly poses a risk to the crew/paramedics and secondly a thorough sterilisation of all environments is required after each trip. Current patient isolation products are unsuitable due to physical size and the inability to fit them within ambulances and more particularly within helicopters and aircraft.

### DISCLOSURE OF INVENTION

According to the present invention, a patient isolation structure comprising a base piece, demountable support ribs over the patient passing above the base sheet, ribs extending downwards, either side of the position of a patient on the base piece support, a patient cover supported in place by the ribs, and said ribs holding the cover away from the position of a patient on the patient support, the ribs being held in position with respect to the patient support.

Embodiments of the invention are set out in the attached claims and/or are set out in the accompanying description of example embodiments of the invention.

### BRIEF DESCRIPTION OF DRAWINGS

FIG. 1 is a perspective view of a first patient isolation structure according to the invention, without the patient harness in place;

FIGS. 2A to 2D illustrate the coupling on the side of the patient isolation structure which opens;

FIGS. 3A to 3D illustrate the hinge on the side of the patient isolation structure where the top sheet is attached to the side panel;

FIG. 4 is an underneath view of the patient isolation structure of FIG. 1 without the patient harness in place;

FIG. 5 illustrates the arrangement beneath the base sheet, showing coupling means to a stretcher or the like;

FIGS. 6A and 6B show the two parts of the sealing unit device holding the patient harness in position in the base sheet of the patient isolation structure of FIG. 1;

FIG. 8 shows detail of the rib connections of FIG. 7.

### DESCRIPTION OF EXAMPLE EMBODIMENTS OF THE INVENTION

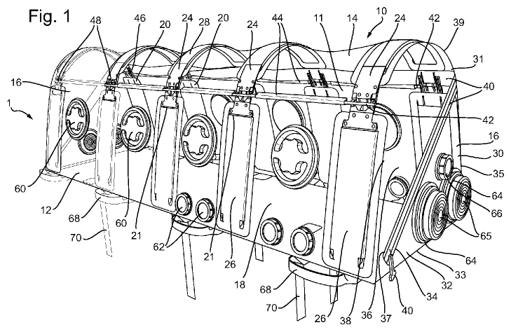

A first embodiment of the invention is illustrated in FIG. 1.

In FIG. 1, a patient isolation structure 1 has a patient cover 10 comprising opposed rectangular side panels 11 and 12, top sheet 14, ends 16, and a base piece in the form of a base sheet 18. Opposed pairs of resilient side ribs 20 and 21 extend upwards on the outside of the patient isolation structure, ribs 20 outside side panels 11 and the other ribs 21 of each pair outside side panels 12. Top ribs 24 extend across the top sheet 14, a top rib extending between the top ends of each pair of ribs 20 and 21. When assembled, each side rib 20 and 21 inclines inwards between its bottom and its top and the top ribs 24 each bend around the top sheet 14, so that the patient cover 10 forms an inverted U-structure clear of anyone inside. The bottoms of the ribs 20 and 21 are welded to the lower part of the side panels 11 and 12, respectively.

Side ribs 20 and 21 are mounted in external sleeves 26 on the side panels 11 and 12 of the patient isolation structure. Top ribs 24 are mounted in sleeves 28 on the outside of the top of the patient isolation structure.

The patient cover 10 has two parts 30 and 31.

The first part 30 of the patient cover 10 comprises is side panel 11 and two substantially triangular end panels 32 (forming part of the ends 16), each of whose bottom edges 33 are welded to base sheet 18. A second edge 34 of the end panels 32 is inclined at angle of 48° to the bottom edge 33, and the third edge 35 at an angle of 76.12° to the bottom edge 33 and is welded to side panel 11, so that side panel 11 is inclined inwards from bottom to top. Thus side panel 11 and the two triangular end panels 32 make up the first part 30 of the patient cover 10.

The second part 31 of the patient cover 10 comprises side panel 12, two end panels 36 (which with panels 32 form the ends 16 of the patient cover 10), and top sheet 14. Each of these end panels 36 has straight edge 37 adjoining the second edges 34 of panels 32 and forming an angle of 48° to the patient base sheet 18, a side edge 38 at an angle of 76.12° to patient base sheet (i.e. 28.12° to the edge 37), and a curved top edge 39. The side edges 38 are welded to the side panel 12 so that side panel 12 is inclined inwards from bottom to top. The curved top edge 39 however is welded to top sheet 14 so the top sheet is free to fold back around over side panel 12.

A single zip 40, airtight when closed, is fitted to the inclined edges 34 and 37 of the end panels 32 and 36, the edge of top sheet 14 adjoining side panel 11 and the long top edge of side panel 11.

By the top edges of side panels 11 and 12 removable rods 42 are fitted in sleeves 44, welded on the outside of the side panels.

Each top rib 14 is coupled to a side rib 20 by a coupling 46 and is pivotally joined to a side rib 21 by a hinge 48.

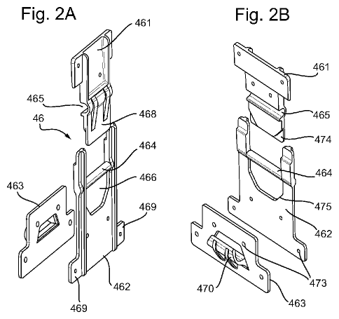

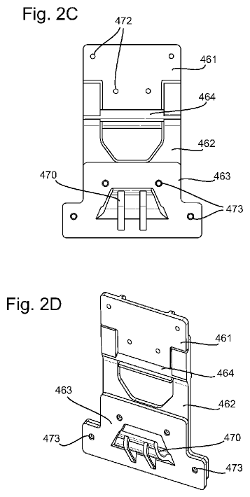

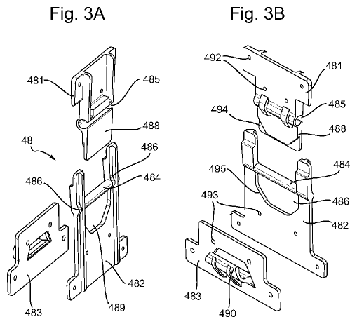

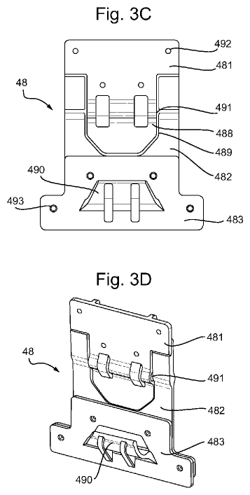

FIGS. 2 and 3 shows more detail of the couplings 46 and hinges 48, respectively.

In FIGS. 2A to 2D, coupling 46 coupling comprises a pivotal member 461, fixed member 462 with a cut-out 466, and a hook member 463 mounted on the lower portion of the fixed member 462. An axle 464 is mounted across the cut out 466. The pivotal member 461 has a transverse U-shaped groove 465 which, when the coupling is engaged, engages around part of the periphery of axle 464. Parallel guides 469 either side of fixed member 462 respectively aid location of the pivotal member when the coupling 46 is put together. A tongue portion 468 of the pivotal member 461 is located in the cut-out 466 when the coupling is assembled. The hook member is mounted on the fixed member and has an upstanding hook 470.

Rivets 472 attach pivotal member 461 to the ends of each of the top ribs 24 on the side of the patient isolation structure where the zip 40 is located. Rivets 473 attach the hook member 463 outside the fixed member 462 and both to the top of a side rib 20. The hook member 463 and fixed member 462 are positioned under the rod 42 on the zip side of the patient isolation structure, with the hook 470 bearing against the rod. Outward pressure resulting from the curved shape of the top rib 24 ensures that the hook 470 remains in position. The U-shaped groove 465 is positioned between the axle 464 and the patient cover 10 so that outward pressure from the top rib 24 to which the pivotal member 461 is attached urge the U-shaped groove into place around axle 464.

The periphery of tongue portion 468 of pivotal member 461 corresponds to the inner periphery of the cut-out 466, the latter having cut off corners 475. However, at the cut-off corners of the tongue portion 468 square cornered tags 474 engage behind the cut-off corners 475, preventing over rotation of the pivotal member 461.

When zip 40 is undone, the ends of top ribs 24 are then pushed inwards slightly releasing the axle 464 from groove 465.

In FIG. 3A to 3D, hinge 48 comprises a pivotal member 481, fixed member 482 with a cut-out 486, and a hook member 483 mounted on the lower portion of the fixed member 482. An axle 484 is mounted across the cut out 486. The pivotal member has a transverse C-shaped groove 485 which, when the coupling is engaged, sits around the axle 484, the groove covering more than 180° of the surface of the axle. Parallel guides 489 are provided side of fixed member 482. A tongue portion 468 of the pivotal member is located in the cut-out 486 when the coupling is assembled. The hook member is mounted above the fixed member and has an upstanding hook 490. The C-shaped groove 485 is a force fit around axle 484, and thus when the groove 485 is engaged with axle 484 and a hinge 491 is formed with pivotal member 481 being able to rotate about axle 484, but not normally to disengage from it.

Rivets 492 attach a pivotal member 481 to the ends of each of the top ribs 24 on the side of the patient isolation structure where the top sheet 14 is welded to side panel 12. Rivets 493 attach the hook member 483 outside the fixed member 482 and both to the tops of each of the side ribs 21. The hook member 483 and fixed member 482 are positioned under the rod 42 adjacent the top of side panel 12, with the hook 491 bearing against the rod 42. Outward pressure resulting from the curved shape of the top ribs 24 ensure that the hook remains in position when the patient isolation structure is in use.

The periphery of tongue portion 488 of pivotal member 482 corresponds to the inner periphery of the cut-out 486 which has cut off corners 495. However, at the cut-off corners square cornered tags 494 engage behind the cut-off corners 495, preventing over rotation of the pivotal member 481.

Although, pivotal member 481 is not normally detached from axle 484, if it becomes necessary to replace part of a hinge 48, the hinge can be separated by forcing C-shaped groove 485 out of engagement with ale 484.

When zip 40 is undone, the ends of top ribs 24 are pushed inwards slightly releasing the axle 464 from groove 465 the top ribs and top sheet can then be rotated around hinges 48 allowing access to the inside of the patient isolation structure. To store the patient isolation structure, zip 40 is undone, and the top sheet 14 and ribs 24 are folded back against side panel 12 and ribs 21. Side panel 11 and ribs 20 are folded down onto the base panel 16, with side panel 12, ribs 21, top sheet 14, and ribs 24, being folded in on top. The whole structure can then be rolled up with the base sheet outside.

The patient isolation structure of FIG. 1 has access ports 60 provided in one or both side panels 11 and 12 through which ancillary equipment may be passed into the isolation structure. Further smaller ports 62 are provided in one or both side panels through which cables and the like to or from monitoring equipment may be passed; air tight seals are provided between such cables and the side panels.

An annular member can be inserted into and then twisted into engagement with a first collar member. A second collar member has an internal thread which engages with an eternal thread one the first collar member, with the wall of the patient cover around the port 60, engaged between the two collar members. To fit a medical glove into the port, the glove is inserted through the annular member with the open end of the glove folded back around the outer rim of the annular member and held in place by an O-ring around the outer end to the annular member. Alternatively, covers may be fitted over one or more ports or airlocks and/or air filters, for example, may be fitted to the ports.

At the ends 16 of the patient cover 10, further ports 64 containing filters 65 are shown. At one end one or more smaller ports 66 could provide a connection to air or oxygen under pressure, or preferably to a pump.

A connection at port 66 to air or oxygen under pressure would allow filtered air or oxygen to be passed into the patient isolation chamber forcing air, carbon dioxide and water vapour out of the patient isolation structure through filters 65. However, it is now recommended that a pump is connected to a smaller port 66 to draw air, excess carbon dioxide and water vapour from the patient isolation structure, and suck air from the surrounding atmosphere through filters 65. This latter arrangement with a pump, means that the pressure inside the patient isolation structure is less than that of the surrounding atmosphere, with the benefit that should the patient cover be punctured, the risk of contamination from the patient is minimised.

It should be noted that the functions of the ports can be interchanged, with, for example, air filters being fitted to one or more ports 60, and a glove to ports 64.

Although flat filters 65 are shown, in some cases, it may be necessary to increase air flow, and in which case high-capacity filters can be used/

In FIG. 1, handles 68 are shown to assist in carrying the structure with straps 70 hanging from the handles 68; these straps 70 can be used for tying the patient isolation structure to bed or stretcher rails.

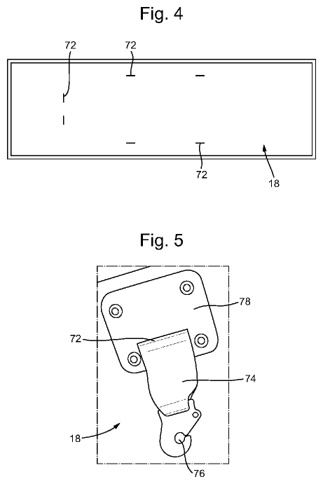

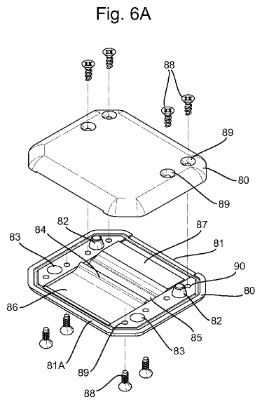

FIGS. 4 and 5 show the base sheet 18 of the patient isolation structure 1. Slots 72 (in this case three pairs) are provided in the base sheet 18. A conventional harness (not shown in FIG. 4) is provided to prevent a patient moving or rolling. The harness has anchor straps 74 (see FIG. 5) passing through the slots 72. The anchor straps have clips 76 at their ends to clip to a mounting point on a stretcher or other mounting. The specific clip 76 design would vary according to the design of any stretcher or mounting with which the patient isolation structure is to be used.

The anchor straps are sealed by sealing units 78 to the base sheet 18 to prevent air entering or leaving the patient isolation structure though the slots 72.

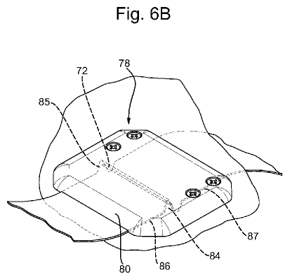

One of these scaling units 78 is shown in more detail in FIGS. 6A and 6B.

The sealing unit 78 comprises two identical rectangular clamping pieces 80 having parallel sides 81 and 81A and bolted above and below the base sheet 18 with a slot 72 between them. Each clamping piece 80 comprises locating lugs 82 to engage corresponding apertures 83 in the other clamping pieces. To one side of the position where the slot 72 would be located when the clamping pieces are joined together, there is a transverse upstanding ridge 84, and on the other side of where the slot 72 would be, a transverse trough 85, parallel to the ridge 84. When the clamping piece is assembled the ridge 84 of one clamping piece is seated in the trough 85 of the other clamping piece. Between the ridge 84 and the edge 81A of the clamping piece, is a wide rectangular depression 86, with sides parallel to the ridge inclined. Between the trough 85 and the opposite edge 81 of the clamping piece is a plateau 87 with inclined sides and whose shape and dimensions enable it to sit within the depression 86 of the other clamping piece when the sealing unit 78 is assembled. Assembly is completed by bolts 88 passing through holes 89 in one clamping member and engaging with threaded holes 90 in the other clamping piece.

On assembly the harness anchor strap 74 of the patient harness passes from the inside of the patient cover into the depression 86 of the lower clamping piece, where it is clamped against the base sheet 18 by the matching plateau 87 of the other clamping piece. The harness anchor strap 74 then passes over ridge 84 of the lower clamping piece where again it is clamped against the base sheet 18 in the trough 85 of the upper clamping piece. The harness anchor strap 74 of the patient harness then passes through slot 72 in the base sheet 18 where, once again, it is clamped with the base sheet 18 between a ridge 84 and trough 85, but this time it is the ridge of the upper clamping piece and the trough is of the lower clamping piece. Finally the harness anchor strap 74 is clamped with the base sheet between the plateau 87 of the lower clamping piece and depression 86 of the upper clamping piece. The clamping method used ensures that the slots 72 cannot allow air into or out of the patient isolation structure 1.

As an alternative to the sealing units 78, although less robust in practice, the harness anchor straps 74 could be glued to the base sheet and the glued area and immediate surround covered with a patch of the same material as the base sheet 18 the cover making the slots 72 completely air tight. However, in practice, it has been found that this method of assembly is insufficiently robust for longer term use.

The material of the patient cover 10 is transparent PVC or PTU (thermoplastic polyurethane). The material of the sleeves 26 and 28 would normally be the same as that of the cover.

Whatever the application, the material of the ribs needs to be resilient, but not so stiff as the be too difficult to bend in practice, it has been found that ribs formed of strips of PVDF (polyvinylidene difluoride) work well. Apart from its mechanical properties, it is highly resistant to solvents, acids, and hydrocarbons.

In a further development, remote monitoring by, say, a specialist of a patient is possible by an attendee at the patient isolation structure (such as an air ambulance paramedic), using goggles and sound equipment to electronically transmit pictures and to converse with the remote monitoring person. With installation of a recorder, it would also be possible to record the conversation with the remote monitor, so that it can be downloaded when a patient arrives at a place for treatment, so that the history of prior treatment given is known.

The embodiment shown in FIG. 1 provides an efficient device for patient care and transfer. Once zipped, the patient isolation structure provides a flexible yet strong and stable structure around the patient. The optically clear panels and access ports 60 allow for full monitoring of the patient

A second much simpler embodiment of the invention is illustrated in FIG. 7. The patient isolation structure 100 has an overall patient cover sheet 101 above and around a base piece 102, which may be the mattress of a hospital bed or of an ambulance. U-shaped semi-rigid support ribs 104 over the base piece 102 and any patient lying thereon.

Each end 105 of each rib 104 engages with a transverse bottom ribs 106 which is passed beneath the patient mattress. The ends 107 of each bottom baton 106 are connected to opposite ends 105 of a rib member 104.

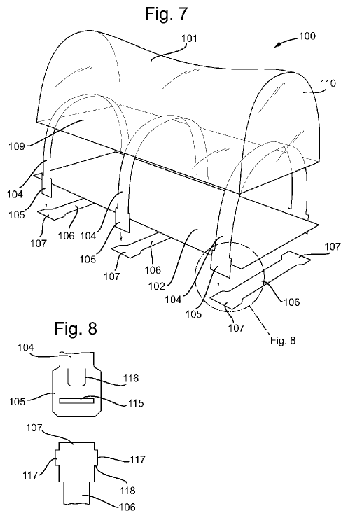

The system for connecting ribs to the bottom batons is shown in FIG. 8.

Each rib end 105 has a transverse slot 115, and a flap 116. The ends 107 of each link member have lateral deformable lugs 118. To connect the transverse bottom ribs 106 to the ribs 104, the ends 107 of the bottom batons 106 are bent upwards end passed through the slots 115, the lugs 117 deform to allow them to pass through the slots. The lugs 117 then engage against ends 105, with the trailing edge 118 of the lugs resting against the periphery of the slots 115. The leading ends of the transverse members are engaged under the flaps 116 to ensure that they do not splay outwards. To disengage the transverse bottom ribs 106 from the ribs 104, a sharp tug on the transverse bottom ribs 106 will cause the lugs 117 to deform and pass pack out through the slots 115.

The ribs 104 are covered by the removable overall cover 101. The cover has sides 109 which extend down over the ribs to the transverse bottom ribs 106 and opposed closed ends 110 which extend down to cover the ends of the base piece 102.

As shown, the overall cover 101 is a loose fit and vents are not needed to allow air to reach a patient on the patient mattress. However, the lower edges of the overall cover 101 could be zipped to or fixed to the base sheet, in which case vents in the cover would be needed. In appropriate cases, forced ventilation is used in manner analogous to the arrangements shown in FIG. 1, with the outlet being filtered if air or oxygen is passed into the patient isolation structure 1 or the inlet filtered if the patient isolation structure is maintained at a pressure less than that of the surrounding atmosphere.

Straps are provided either side of the patient mattress, particularly if the later incorporated a rigid board member or frame to allow the structure to be carried.

The embodiment of FIG. 7 is intended for emergency shelter for patients and as an emergency isolation unit for transporting patients within vehicles or hospitals or as an emergency isolation unit or infection control unit for field hospitals and for infection control surgery. As such it can be used to isolate a potentially contagious patient and protect them from the elements whilst waiting for transport or used in a hospital ward providing short term/or staff or in a doctor's surgery setting where there may be a need to protect against aerosol transmission of contagion.

The transverse bottom ribs 106 are slid under the patient and the ribs 104 locked in place in under a minute.

The ribs and batons are easily cleaned after use, can be re-used multiple times, and are stored in their own protective case.

The base piece 102 can be part of the structure by attaching the transverse bottom ribs 106 underneath the base piece 102 through sleeves. This arrangement gives extra stability to the structure and allows the patient to be moved between separate locations quickly and effectively. The patient isolation structure can be used in conjunction with existing ambulance stretcher. If the base piece is a mattress, an extra layer of comfort is given to the patient. The base piece 102 being part of the structure allows the unit to be slid from stretcher to bed (or vice versa) without removing the protective cover.

1. A patient isolation structure comprising a base sheet (18) and a patient cover (10) attached to the base sheet (18), characterised in that the patient cover (18) comprises side pieces (11, 12) and a top sheet (14) in which, when the patient isolation structure is erected:
pairs of resilient side ribs (20,21) are attached to the outside of the side pieces (11, 12) and resilient top ribs (24) are attached to the outside of the top sheet (14);
the resilient side ribs (11, 12) extend upwards;
each resilient top rib (24) extends between a pair of side ribs (11,12), each top rib (24) being pivotally connected by a hinge (48) at one end to the end of one (21) of a pair of side ribs (20, 21), and the other end of each top rib (24) having a coupling (46) to be engaged with or disengaged from the top of the other side rib (20) of the pair of ribs (20, 21), all of said hinges (48) being aligned towards one side of the patient isolation structure and all of said couplings (46) being aligned towards the other side of the patient isolation structure, and when said couplings (46) are disengaged each hinge (48) allows the attached top rib (14) to rotate thereby opening the patient isolation structure (10).

2. The patient isolation structure of claim 1 characterised in that the couplings (46) each comprise a pivotal member (461) attached to a top rib and a fixed member (462) is attached to a side rib (20) on one side of the patient isolation structure, the pivotal member (461) having a groove (465) which may be engaged with or disengaged from an axle (464) traversing an aperture in the fixed member (462) and in use the groove (465) lies between the axle (464) and the patient cover (10).

3. The patient isolation structure of claim 1 characterised in that the hinges (48) each comprise a pivotal member (481) which is attached to a top rib (24) and a fixed member (482) attached to a side rib (20) on one side of the patient isolation structure the pivotal member is pivotally mounted about an axle (484) traversing an aperture in the fixed member (482).

4. The patient isolation structure of claim 2 characterised in that the couplings and hinges each have a hook member (463, 483) mounted on the fixed member (462, 482) with an outwardly oriented hook (470,490) which in use engages a rod (42) at the top of aside panel (11,12).

5. The patient isolation structure of claim 4 characterised in that the rods (42) are mounted in sleeves (44).

6. The patient isolation structure of claim 1 characterised in having a patient harness with anchoring straps (74) and in that the base sheet (18) has slots (72) though which the anchoring straps (72) pass, said slots having seals (78) to prevent air passage into or out of the patient isolation structure (1).

7. The patient isolation structure of claim 6 characterised in that the anchoring straps (72) have clips (76) outside the patient isolation structure to attach the anchoring straps to mounting points on a stretcher or other support.

8. The patient isolation structure of claim 6 characterised in that the seals comprise two clamping pieces (80), one clamp piece mounted above a slot (72) and the other clamp piece mounted below the slot (72), with an anchoring strap (74) and the base sheet (18) clamped between the two clamping pieces (80).

9. The patient isolation structure of claim 8 characterised in that the clamping pieces (80) are identical, each clamping piece (80) having a transverse ridge (84) and transverse trough (85) and, when assembled, the ridge (84) of one clamping piece engages the trough (85) of the other clamping piece with the anchoring strap (74) and base sheet (18) clamped between the ridge (84) and the trough (85), and in that the slot (72) in the base sheet (18) though which the anchoring strap (74) passes lies between the pairs of ridges (84) and troughs (85).

10. The patient isolation structure of claim 9 characterised in that each clamp piece (80) has a depression (87) between the transverse ridge (84) and one edge (81) of the clamping piece and a depression (88) between the transverse trough (85) and an opposite edge (81A) of the clamping piece and, when assembled, the depression (88) of one clamp piece is engaged by the plateau (87) of the other clamping piece with the anchoring strap (74) and base sheet (18) clamped between the depression (87) and the plateau (88).

11. A patient isolation structure (100) comprising a base piece (102), demountable support ribs (104) passing above the base piece (102), the demountable support ribs (104) extending downwards in an inverted U-shape either side of the position of a patient on the base piece (102), a patient cover (101) supported in place by the ribs (104), said ribs (104) holding the cover (101) away from the position of a patient on the base piece (102) characterised in that each rib (104) is engageable at either end with a transverse bottom baton (106) beneath the base piece (102), each end (107) of a transverse bottom baton (106) connecting with opposite ends (105) of a rib member (104).

12. The patient isolation structure of claim 11 in which bottom sleeves are provided below the base piece (102), the bottom sleeves being transverse partially across the bottom of base piece, and in use, the transverse bottom baton (106) are mounted in the sleeves.
